(19) United States
(12) Patent Application Publication
(10) Pub. No.: US 2009/0127280 A1
(43) Pub. Date: May 21, 2009

(54) Multi material dispensing gun

(76) Inventor: Jerry Kieft, Ashland, OH (US)

Correspondence Address: WALKER & JOCKE, L.P.A., 231 SOUTH BROADWAY STREET, MEDINA, OH, 44256, US

(21) Appl. No.: 11/985,593

(22) Filed: Nov. 15, 2007

(51) Int. Cl. B67D 5/06; B67D 5/52

(52) U.S. Cl. 222/1; 222/135

(57) ABSTRACT

A multi material dispensing gun that can receive high pressure different materials therein, keep the materials separated, and then simultaneously dispense the materials therefrom. Valves are positioned in the gun to permit leading seals of barrier fluid chambers to be subject to the high pressure only during gun dispensing. Dispense pins control opening and closing of the valves. A manual trigger can be used to control movement of the dispense pins via an actuator arrangement. The valves, dispense pins, and barrier fluid chambers are part of a replaceable modular gun segment. This segment is removably connected to a dispense segment that includes the material inlets and dispense outlets.

### TECHNICAL FIELD

This invention relates to a material dispensing apparatus and method.

### BACKGROUND ART

Material dispensing guns and their operation are well known in the art. Some dispensing guns can dispense one or more materials. However, there are several problems associated with the design and operation of these prior art dispensing guns. For example, high pressure material requirements can result in a complex arrangement of parts. Replacement of a defective part, if even possible, can require extensive disassembly and the handling of numerous non-defective parts, as well as the materials to be dispensed. Thus, part replacement can be time consuming, cumbersome, and messy.

### DISCLOSURE OF THE INVENTION

Thus, there exists a need for a dispensing gun apparatus that can be used with pressurized materials but without a complex mechanical arrangement of components. Thus, enabling a simpler and more efficient part replacement process.

It is an object of an exemplary form of the present invention to provide a dispensing apparatus and method.

It is an object of an exemplary form of the present invention to provide a high pressure material dispensing gun apparatus that is more readily repairable.

It is a further object of an exemplary form of the present invention to provide a method of replacing dispensing gun parts or components thereof.

It is a further object of an exemplary form of the present invention to provide structure and method for protecting and extending the seal life in a high pressure dispensing gun.

Further objects of the present invention will be made apparent from the following Best Mode for Carrying Out Invention and the appended Claims.

The foregoing objects are accomplished in the preferred embodiment of the present invention by an apparatus and method for a multi material combining dispensing gun.

In an exemplary form of the invention the dispensing gun includes a barrier fluid chamber having seals. The dispensing gun provides for a novel fluid material control arrangement which only allows the barrier fluid chamber seals to be subject to high pressure during gun dispensing operation. Thus, barrier fluid chamber seals are not exposed to high pressure fluid material during non dispensing operation of the gun. The novel fluid material control arrangement provides for longer barrier fluid chamber seal life and shorter gun down time. Modular features of the dispensing gun also result in less cumbersome part replacement.

### BRIEF DESCRIPTION OF DRAWINGS

FIG. 1 shows a cross-sectional side view of an exemplary material dispensing gun of the invention.

FIG. 2 shows a cross-sectional top view of the dispensing gun of FIG. 1.

FIG. 3 shows a valve of the dispensing gun in an open position.

FIG. 4 shows an exemplary material dispense system which includes the dispensing gun of FIG. 1.

FIG. 5 shows a dispensing gun combining block having plural combining block chambers, each fluidly connected to a different material outlet opening.

### BEST MODE FOR CARRYING OUT INVENTION

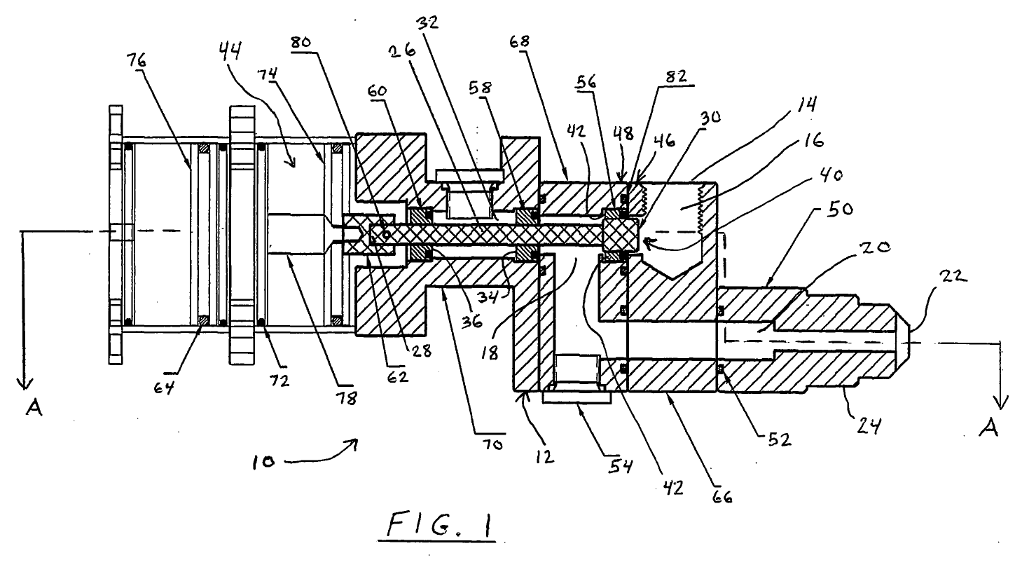

FIG. 1 shows a cross-sectional side view of an exemplary apparatus of the present invention. The apparatus comprises a dispensing gun 10.

It should be understood that although the apparatus components may be described herein with reference to a dispensing gun, it is within the scope of the present invention for the novel apparatus components to also be applicable with other types of dispensing mechanisms. It should also be understood that although the dispensing gun components may be described herein with reference to high pressure dispensing, it is within the scope of the present invention for the novel dispensing gun components to also be applicable with dispensing guns of other pressures.

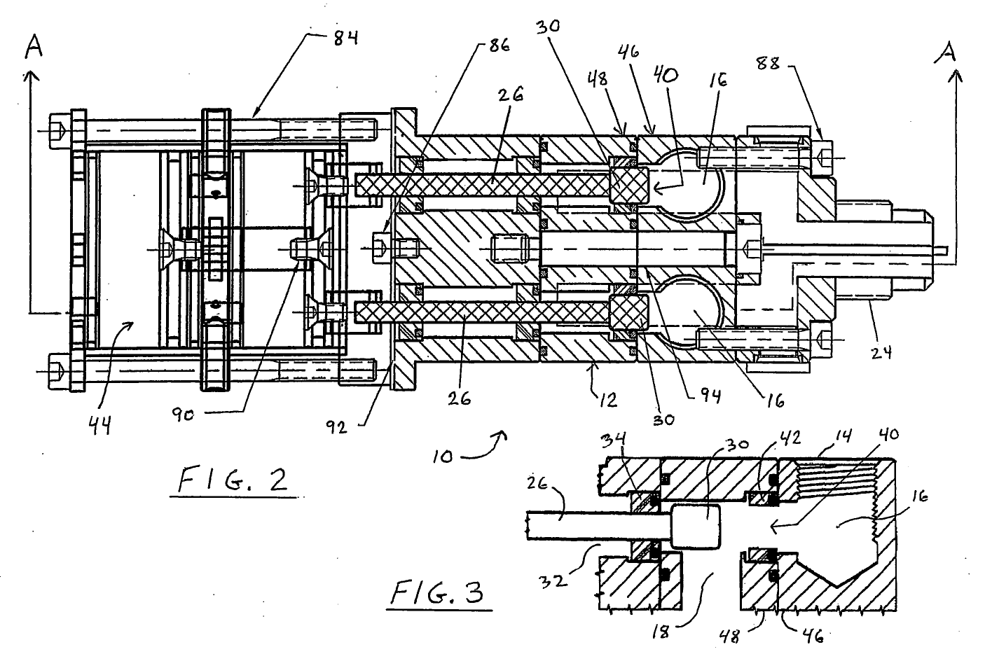

FIG. 2 shows a cross-sectional top view of the dispensing gun 10 of FIG. 1. FIG. 2 is taken along line A-A of FIG. 1. Correspondingly, FIG. 1 is taken along line A-A of FIG. 2. As can be seen, the exemplary material dispensing gun 10 of FIG. 2 is generally symmetrical. FIG. 1 shows a side section of the gun 10.

FIG. 1 shows paths for fluid materials inside of a body 12 of the gun 10. Fluid material is received in the gun 10 through inlets 14 comprising an inlet passage 16. Each inlet passage 16 is adapted to receive therein a high pressure fluid material from a respective material source. The opening to an inlet passage 16 can be threaded to enable the source of high pressure material to be securely connected thereto.

Downstream of each inlet passage 16 is an interior passage 18. Each interior passage 18 is in fluid communication with a respective inlet passage 16. Each interior passage 18 is also in fluid communication with a respective downstream chamber 20. Each different material can simultaneously flow into the gun and downstream to a respective chamber 20.

Downstream of each respective chamber 20 is a respective material outlet opening 22. The outlet opening 22 is configured to enable the material received through inlet passage 16 to be dispensed therethrough out of the gun 10. Thus, an outlet opening 22 is where a material exits the gun. The outlet opening 22 may be an end part of an elongated outlet block or combining block 24, which has an outlet axis and a diameter.

The combining block 24 encompasses the combining block chamber 20. The outlet openings 22 may be angled toward each other to contribute to the contacting or mixing of different materials immediately after they have been dispensed from the gun 10.

The types of materials dispensable from a dispensing gun are well known in the art. The types of interaction that can occur between these dispensed materials is also well known in the art. For example, after dispensed, a multi-part resultant material may be formed outside of the gun by any of material combining, mixing, blending, amalgamation, bonding, compounding, marrying, coupling, connecting, fusing, compositing, metallurgical reactions, and/or chemical reactions, etc. Thus, based on the different materials supplied into the gun 10, corresponding different types of material interactions can occur as a result of the gun dispensing.

A resultant material that is comprised of or formed from different materials may also comprise a single or unitary material body. For example, an adhesive may be formed upon the mixing of two materials being simultaneously separately dispensed from the gun 10. The two materials may be mixed to form the adhesive in a mixing chamber (e.g., a mixing sleeve and/or a mixing tube). The mixing chamber may be removably attached to the gun. The mixing chamber may also be disposable.

It should be understood that many other material interactions (other than combining) can occur as a result of different separate materials being simultaneously dispensed from the gun 10. Thus, the language “combined materials”, “material combination”, “resultant materials”, and “resultant multi-part material” can all similarly refer to the final form of material(s) subsequent to their simultaneous dispensing from the gun.

The gun body 12 also includes dispense elements 26. A dispense element may comprise a rod, elongated cylindrical rod, shaft, pin, or other type of movable member. For simplicity, a gun dispense element will be referred to herein as a dispense pin. Each dispense pin 26 is axially movable in a direction parallel to its axis. Each axis of the dispense pins can be substantially parallel to each other. Each dispense pin axis can also be substantially parallel to each axis of the gun outlet openings 22. However, it should be understood that other orientations may be used. In an exemplary arrangement, an outlet opening axis can be oriented from 0 degrees (i.e., parallel) through 90 degrees (i.e., perpendicular) relative to a dispense pin axis. Similarly, an axis of an inlet passage 16 can be oriented 0-90 degrees relative to a dispense pin 26 axis and/or an outlet opening 22 axis.

Each dispense pin 26 also includes a first (valve or plunger) end 30 and a second (actuator) end 28. As discussed in more detail later, the first end 30 is associated with a valve arrangement, and the second end is associated with an actuator (e.g., a piston). As shown in FIG. 1, the first end 30 of a dispense pin 26 is (axially) located in its respective fluid material path (relative to the dispense pin axis or gun outlet axis) between the second end 28 of the dispense pin 26 and the gun outlet opening 22. As discussed in more detail later, the dispense pins 26 (or dispense control pins) act to control flow of material through the gun 10.

The valve end 30 when closed creates a “snuff back” action that causes material to be cut off or interrupted at the outlet opening 22 to prevent dispensed material from hanging or suspending from the gun. Also, as shown in FIG. 1, the dispense pin valve end 30 can have a larger diameter than the dispense pin actuator end 28. An enlarged valve end 30 can be used to create a larger snuff back effect. The use of an enlarged valve end 30 can also allow for a larger volume of material to flow through the gun 10.

Alternatively, in other arrangements the dispense pin valve end 30 can have substantially the same diameter as the dispense pin actuator end 28. The entire dispense pin 26 may have a constant diameter.

The gun body 12 also includes barrier fluid chambers 32. Purpose and operation of barrier fluid and a barrier fluid chamber are known in the art. However, in the exemplary gun 10 each barrier fluid chamber 32 is bounded by a first end seal arrangement 34 and a second end seal arrangement 36. As discussed in more detail later, the first (or high pressure) end seal arrangement 34 is positioned in the gun to be exposed to high pressure. Conversely, the second (or low pressure) end seal arrangement 36 is situated in the gun to be exposed to a relatively low pressure. Each dispense pin 26 extends through a barrier fluid chamber 32. Thus, each dispense pin 26 includes a portion thereof that extends into and is movable relative to a respective barrier fluid chamber 32. Each respective dispense pin 26 also extends through the end seal arrangements 34, 36 of a respective barrier fluid chamber 32.

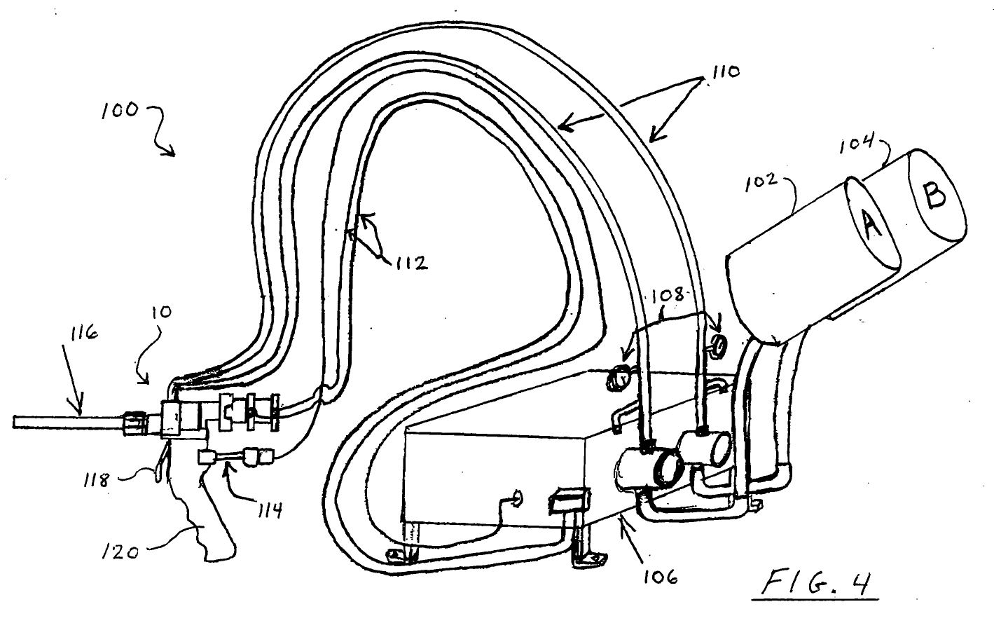

The gun body 12 also includes a respective valve arrangement 40 located between each adjacent inlet passage 16 and interior passage 18. Each valve arrangement 40 includes a valve seal arrangement 42 and a dispense pin valve end 30 (or dispense pin plunger). Each pin valve end 30 is axially movable relative to its adjacent valve seal arrangement 42 between a valve closed position and a valve open position. A valve closed position is shown in FIG. 1. A valve open position is shown in FIG. 3.

In the valve closed position, the pin valve end 30 sealingly engages the valve seal arrangement 42. This sealing engagement blocks and prevents flow of material from the adjacent inlet passage 16 into the adjacent interior passage 18.

The gun 10 also includes at least one actuator 44. An actuator 44 may comprise a fluid (pneumatic or hydraulic) type of piston/cylinder. In other arrangements, other types of actuators can be used. Each dispense pin 26 is in operative connection with an actuator 44. An actuator 44 is operative to cause a dispense pin valve end 30 to axially move between its valve closed position and its valve open position. An actuator may be arranged in a gun to operate independently (alone) to move a dispense pin. Alternatively, an actuator may be arranged to operate in tandem with one or more other actuators in moving a dispense pin.

Gun actuators 44 are operative to allow each valve arrangement 40 to be in an open condition at the same time (simultaneously). Having each valve 40 open enables different materials to each respectively travel in separated flow paths through the gun. The gun arrangement allows each respective material to flow through a designated inlet passage 16, interior passage 18, chamber 20, and outlet opening 22.

A gun actuator can be manually or robotically controlled. For example, a manual gun trigger can be linked to an actuator. Pulling of the trigger would cause operation of the actuator, which in turn would cause movement of an operatively connected dispense pin to its valve open position, which in turn would allow fluid material to flow into and through the gun in performing a gun dispensing operation. An actuator may be robotically controlled without use of a trigger.

During gun dispensing the dispense pin valve end 30 is axially positioned in the valve open position. A valve end 30 in the valve open position is disengaged from its respective valve seal arrangement 42. This valve end 30 movement permits material to flow out of the inlet passage 16 and into the adjacent interior passage 18. That is, as result of an open valve condition the high pressure material can move out of the inlet passage 16, through the open valve 40, and into the interior passage 18. However, a seal arrangement 34 for the barrier fluid chamber 32 is adjacent to and in constant fluid communication with the interior passage 18. Thus, an open valve condition also causes the high pressure seal arrangement 34 to become externally subjected to high pressure.

In an exemplary embodiment, during gun dispensing each respective dispense pin valve end 30 is retracted in a direction away from a valve seal arrangement 42, toward the barrier fluid chamber 32, and into the interior passage 18. That is, the dispense pin 26 in FIG. 1 is moved (as shown in FIG. 3) to the left to enable gun dispensing. As discussed in more detail later, in other alternative embodiments a dispense pin also may be linked so that it is moved in the opposite direction (toward the inlet passage 16) to allow material flow and gun dispensing.

During non dispensing, each dispense pin 26 is axially positioned to maintain a closed valve condition. Thus, during non dispensing the front or leading seal 58 of each barrier fluid chamber 32 is kept or prevented from being subjected to high pressure. Because the high pressure seal arrangement 34, which includes the front seal 58, is only subject to high pressure during actual gun dispensing operation, the life of the seal arrangement 34 is extended (and barrier fluid chamber life protected thereby).

In an exemplary arrangement the gun body 12 is partitioned or divided into segments or sections. The arrangement facilitates gun repair and part replacement. For example, in the exemplary arrangement the gun body 12 includes a dispense segment 46 and a modular valve segment 48. The dispense segment 46 includes the fluid material inlet passages 16, chambers 20, and combined material outlet openings 22. The valve segment 48 includes the valves 40, dispense pins 26, interior passages 18, and barrier fluid chambers 32. The valve segment 48 can also include the actuators 44.

The valve segment 48 is removably connected to the dispense segment 46. The modularity arrangement enables the valve segment 48 to be quickly removed and replaced with another (new) valve segment. Valve segment 48 replacement can be carried out very simply in the field. Material inlet hoses need not be removed during valve segment replacement. Thus, the exemplary modularity arrangement of gun body 12 can significantly reduce gun down time.

The exemplary dispensing gun 10 shown in FIGS. 1 and 2 can also include components corresponding to a material marrying block 50, O-ring 52, high pressure threaded plug 54, high pressure seals 56, 58, low pressure seal 60, dispense pin receiver or connecter 62, dynamic O-ring 64, material inlet block 66, center block 68, pin block 70, static O-ring 72, front actuator 74, rear actuator 76, cylinder shaft 78, retention pin 80, O-ring 82, socket head cap screws 84, 86, 88, flat socket cap screw 90, seal retention plate 92, and an alignment shoulder screw 94.

FIG. 4 shows an exemplary dual material dispense system 100 which can include the previously discussed dispense gun 10. The gun 10 is shown connected to containers 102, 104 of material. For example, the material may comprise different materials A and B having different properties. Further, the materials A and B may be combinable to form adhesives, sealants, molding compounds, etc.

Also shown in FIG. 4 are a metering system 106, gauges 108, high pressure dispense hoses 110, fluid cylinder lines 112 (e.g., air lines), a switch wire 114, attachable/removable mixing chamber 116, a gun trigger 118 (which may be manually actuated), and a gun handle 120. The material containers 102, 104 can be used with a variety of pumps. For example, a pump may be any of a rotary, rod displacement, and/or piston type of pump. The system 100 enables the dispense gun 10 to receive the fluid materials from the containers 102, 104 under high pressure. The air lines 112 can be used to operate one or more piston actuators 44 in the gun 10.

It should be understood that an exemplary dispensing gun apparatus of the invention is able to receive a plurality of different materials and then dispense these received materials from the gun. For example, exemplary dispensing guns can respectively receive two, three, four, or more separate different materials to be dispensed.

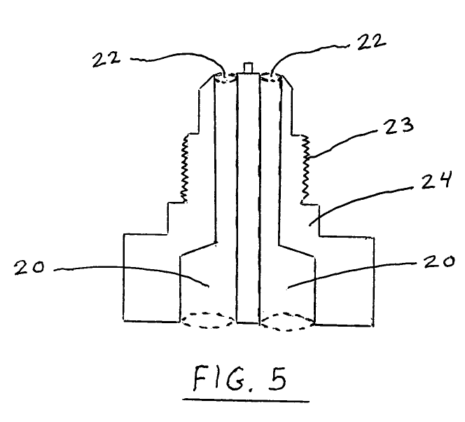

FIG. 5 shows a dispensing gun outlet arrangement sliced along the longitudinal axis. The combining block 24 has plural combining block chambers 20 therein. The combining block chambers 20 lead to respective material outlet openings 22. The treaded section 23 can be used to attach mixer components, such as a disposable mixing sleeve 116, in which different materials dispensed through the plural outlets 22 can be combined or mixed. Respective entrances to the chambers 20 and respective exits from the outlets 22 are represented by broken lines.

Also, an exemplary dispensing gun that is capable of dispensing multi materials can also be used to dispense less than its material maximum. For example, a dispensing gun capable of dispensing two (dual) materials can also be used to dispense only a single material. Likewise, a dispensing gun capable of receiving three materials (through three separate fluid inlets) can also be used to dispense only two materials. One or more fluid inlets can be closed. Additionally, an alternative dispensing gun may have only a sole fluid inlet, be able to receive only one material, and be able to dispense that material. Also, depending on the gun arrangement, the appropriate number of valves 40 needing to be opened (or closed) can be selectively controlled or manipulated.

An exemplary dispensing gun enables two or more materials to be simultaneously separately received into the gun, kept separated while in the gun, and then simultaneously dispensed from the gun. As previously discussed, gun outlets 22 may be angled to facilitate the merging of different materials being dispensed from the gun 10. Thus, an exemplary dispensing gun allows for different materials to be separately received into the gun, separately dispensed from the gun through different adjacent outlets, and then combined (brought together) outside the gun due to the nature of their dispensing.

The quantity of like components in a dispensing gun can vary according to the quantity of materials the gun can receive. For example, an exemplary dual material dispensing gun may include one marrying block 50, four O-rings 52, six high pressure threaded plugs 54, two large high pressure seals 56, two small high pressure seals 58, two inlets 14, two dispense pins 26, two valves 40, two barrier fluid chambers 32, two (front and rear) actuators 44, two low pressure seals 60, two dispense pin receivers 62, two dynamic O-rings 64, one material inlet block 66, one center block 68, one pin block 70, three static O-rings 72, one front piston 74, one rear piston 76, one cylinder shaft 78, two retention pins 80, four O-rings 82, four socket head cap screws 84, one socket head cap screw 86, four socket head cap screws 88, four flat socket cap screws 90, one seal retention plate 92, three shoulder screws 94, two chambers 20, and two exit openings 22. An exemplary high pressure material dispensing gun has a normal maximum pressure of about 3000 psi. Thus, it can be used with pressures ranging from greater than 0 to about 3000 psi. Another exemplary gun embodiment is operable up to pressures of approximately 4000 psi.

An exemplary gun dispensing operation will now be described with regard to FIGS. 1-4. Pressure applied to the gun trigger 118 allows the air lines 112 to cause actuator-induced movement of the dispense pins 26 out of sealing engagement at the respective valves 40. With the valves 40 now open, the different materials can flow under high pressure from their respective sources through the inlet passages 16 and into the interior passages 18. The different materials can further continue their flow and enter respective chambers 20. The different materials then flow out of the chambers 20 and toward their respective exit openings 22. Release of the gun trigger 118 causes the valves 40 to become closed, which in turn stops any additional flow of the materials into the gun 10.

In a further exemplary embodiment, an additional large high pressure seal (like seal 56) is located externally adjacent to but axially disposed from the high pressure seal arrangement 34 of the barrier fluid chamber 32. With the valve 40 being open, the dispense pin valve end 30 is situated in sealing engagement with this additional high pressure seal. The front side of the valve end 30 can be used to close the valve 40 as previously discussed, whereas the back side of the valve end 30 can be used to contact the additional large high pressure seal to seal off the outside area next to the high pressure seal arrangement 34. This sealing engagement prevents the seal arrangement 34 from being directly subjected to a high pressure material that passes through the open valve 40. Thus, in this further exemplary embodiment the barrier fluid chamber 32 can be protected from high pressure exposure whether the valve 40 is closed or open (e.g., protected at all times).

Thus, the novel apparatus of the exemplary forms of the present invention achieves at least one of the above stated objectives, eliminates difficulties encountered in the use of prior devices and systems, solves problems, and attains the desirable results described herein.

In the foregoing description, certain terms have been used for brevity, clarity, and understanding. However, no unnecessary limitations are to be implied therefrom because such terms are for descriptive purposes and are intended to be broadly construed. Moreover, the descriptions and illustrations herein are by way of examples and the invention is not limited to the details shown and described.

In the following claims, any feature described as a means for performing a function shall be construed as encompassing any means capable of performing the recited function, and shall not be limited to the particular means used for performing the function in the foregoing description, or mere equivalents.

Having described the features, discoveries and principles of the invention, the manner in which it is constructed and operated and the advantages and useful results attained, the new and useful structures, devices, elements, arrangements, parts, combinations, systems, equipment, operations, methods, processes, and relationships are set forth in the appended claims.

1. Apparatus including:
a dispensing gun operative to simultaneously dispense separated materials therefrom,
wherein the gun includes:
material outlet passages,
wherein the material outlet passages allow material exit from the gun,
material inlet passages,
wherein each respective material inlet passage is adapted to receive pressured material from at least one pressurized material source,
wherein during gun dispensing, each respectively material inlet passage is in fluid communication with a respective outlet passage enabling different materials to be received into the gun and dispensed therefrom through the outlet passages,
at least one barrier fluid chamber,
wherein each barrier fluid chamber includes an end seal arrangement,
at least one dispense control pin,
wherein each dispense control pin includes an axis,
wherein each dispense control pin is movable in an axial direction,
wherein each respective dispense control pin includes a pin portion that extends into and is movable relative to a respective barrier fluid chamber,
wherein during gun dispensing, each dispense control pin is axially positioned to allow the end seal arrangement of each barrier fluid chamber to be in fluid communication with at least one material inlet passage and to be externally subjected to pressurized material source pressure,
wherein during gun non dispensing, each dispense control pin is axially positioned to prevent the end seal arrangement of each barrier fluid chamber from being in fluid communication with the at least one material inlet passage and from being externally subjected to pressurized material source pressure.

2. The apparatus according to claim 1
wherein the material outlet passages include a first material outlet passage and second material outlet passage,
wherein the material inlet passages include a first material inlet passage and second material inlet passage,
wherein the first material inlet passage is adapted to receive a first high pressure fluid material from a first source,
wherein the second material inlet passage is adapted to receive a second high pressure fluid material from a second source,
wherein during gun dispensing, the first material inlet passage is in fluid communication with the first material outlet passage and the second material inlet passage is in fluid communication with the second material outlet passage, enabling a first high pressure fluid material and second high pressure fluid material combination to be dispensed from the gun.

3. The apparatus according to claim 2
wherein the at least one dispense control pin includes a first dispense pin and a second dispense pin,
wherein at least a portion of the first dispense pin extends into and is axially movable relative to a barrier fluid chamber,
wherein at least a portion of the second dispense pin extends into and is axially movable relative to a barrier fluid chamber.

4. The apparatus according to claim 3
wherein the first dispense pin is axially movable in a first axial direction,
wherein the second dispense pin is axially movable in a second axial direction,
wherein the second axial direction is substantially parallel to the first axial direction,
wherein each outlet passage includes an outlet axis,
wherein each outlet axis is substantially parallel to the second axial direction.

5. The apparatus according to claim 3
wherein the at least one barrier fluid chamber include a first barrier fluid chamber and a second barrier fluid chamber,
wherein the first barrier fluid chamber includes a first end seal arrangement,
wherein the second barrier fluid chamber includes a second end seal arrangement,
wherein at least a portion of the first dispense pin extends into the first barrier fluid chamber,
wherein the first dispense pin is axially movable relative to the first barrier fluid chamber,
wherein with the first dispense pin in a first axial position, first high pressure fluid material is allowed to flow from the first material inlet passage to the first material outlet passage and externally subject the first end seal arrangement to the first high pressure fluid material,
wherein with the first dispense pin in a second axial position, the first high pressure fluid material is prevented from flowing from the first material
inlet passage to the first material outlet passage and from subjecting the first end seal arrangement to the first high pressure fluid material,
wherein at least a portion of the second dispense pin extends into the second barrier fluid chamber,
wherein the second dispense pin is axially movable relative to the second barrier fluid chamber,
wherein with the second dispense pin in a first axial position, second high pressure fluid material is allowed to flow from the second material inlet passage to the second material outlet passage and externally subject the second end seal arrangement to the second high pressure fluid material,
wherein with the second dispense pin in a second axial position, the second high pressure fluid material is prevented from flowing from the second material inlet passage to the second material outlet passage and from subjecting the second end seal arrangement to the second high pressure fluid material.

6. The apparatus according to claim 5 wherein the gun includes valve arrangements,
wherein a first valve arrangement is located in a first fluid path between the first material inlet passage and the first barrier fluid chamber,
wherein a second valve arrangement is located in a second fluid path between the second material inlet passage and the second barrier fluid chamber,
wherein the first dispense pin includes a valve end and an actuated end,
wherein in the first axial position of the first dispense pin the first dispense pin valve end causes the first valve arrangement to be open,
wherein in the second axial position of the first dispense pin the first dispense pin valve end causes the first valve arrangement to be closed,
wherein the second dispense pin includes a valve end and an actuated end,
wherein in the first axial position of the second dispense pin the second dispense pin valve end causes the second valve arrangement to be open,
wherein in the second axial position of the second dispense pin the second dispense pin valve end causes the second valve arrangement to be closed.

7. The apparatus according to claim 6
wherein the first dispense pin has a valve end diameter and an actuated end diameter,
wherein the first dispense pin valve end diameter is larger than the first dispense pin actuated end diameter,
wherein the second dispense pin has a valve end diameter and an actuated end diameter,
wherein the second dispense pin valve end diameter is larger than the second dispense pin actuated end diameter.

8. The apparatus according to claim 6 wherein each valve arrangement comprises a valve seal,
wherein each respective valve end is movable relative to a respective valve seal between a valve closed position and a valve open position, wherein in the valve closed position the respective valve end engages the respective valve seal, wherein in the valve open position the respective valve end is retracted from the respective valve seal in a direction away from a respective material inlet passage.

9. The apparatus according to claim 6 wherein the gun includes a body,
wherein the body comprises a dispense segment and a modular valve segment,
wherein the dispense segment includes each material inlet passage and the outlet passage,
wherein the valve segment includes each dispense pin, each valve arrangement, and each barrier fluid chamber,
wherein the valve segment is removably connected to the dispense segment,
wherein the valve segment is replaceable with another valve segment.

10. The apparatus according to claim 1 wherein the dispensing gun further comprises at least one actuator,
wherein the at least one dispense control pin comprises plural dispense control pins,
wherein the at least one actuator is in operative connection with the dispense control pins,
wherein the at least one actuator is operative to cause the dispense control pins to be simultaneously axially moved to a position enabling different high pressure fluid materials to be separately received into the gun and separately dispensed from the gun.

11. The apparatus according to claim 10 wherein the dispense control pins include a first dispense pin and second dispense pin, wherein a sole actuator is in operative connection with both the first dispense pin and the second dispense pin.

12. The apparatus according to claim 10 wherein the dispensing gun further comprises a manually actuated dispensing control trigger, wherein the trigger controls operation of the at least one actuator.

13. The apparatus according to claim 10 wherein the at least one actuator includes at least one of a pneumatic piston and a hydraulic piston.

14. The apparatus according to claim 1
wherein during gun dispensing, each respective dispense pin is retracted away from a respective adjacent material inlet passage enabling high pressure fluid material to flow out of the respective adjacent material inlet passage,
wherein during gun non dispensing, each respective dispense pin respectively blocks high pressure fluid material from flowing out of the respective adjacent material inlet passage.

15. The apparatus according to claim 14 and further comprising high pressure material sources,
wherein the dispensing gun comprise a high pressure dispensing gun,
wherein the material inlet passages comprise high pressure fluid material inlet passages,
wherein each respective high pressure fluid material inlet passage is connected to a respective high pressure fluid material source,
wherein each respective high pressure fluid material inlet passage includes a respective high pressure fluid material therein,
wherein during gun dispensing, a first high pressure fluid material from a first high pressure fluid material inlet passage provides high pressure against an end seal arrangement of a first barrier fluid chamber,
wherein during gun non dispensing, the first high pressure fluid material is prevented from providing high pressure against the end seal arrangement of the first barrier fluid chamber.

16. A method comprising:
(a) operating a dispensing gun to cause pressured separate different materials to be received therein through respective fluid material inlet passages,
wherein the gun includes the high pressure fluid material inlet passages, at least one outlet passage, at least one barrier fluid chamber, and at least one dispense control pin,
wherein each dispense control pin includes an axis,
wherein each dispense control pin is movable in an axial direction,
wherein each respective dispense control pin includes a pin portion that extends into and is movable relative to a respective barrier fluid chamber,
wherein each barrier fluid chamber includes a leading seal,
wherein during gun dispensing, each dispense control pin is axially positioned to allow each leading seal to be in fluid communication with at least one material inlet passage and be externally subjected to pressurized material source pressure,
wherein during gun non dispensing, each dispense control pin is axially positioned to prevent each leading seal from being in fluid communication with the at least one material inlet passage and from being externally subjected to pressurized material source pressure;
(b) subsequent to step (a), farther operating the dispensing gun to cause the pressured separate different materials received in step (a) to separately flow toward the at least one outlet passage;
(c) subsequent to step (b), further operating the dispensing gun to cause the materials to be dispensed through the at least one outlet passage, wherein each material inlet passage is in fluid communication with the at least one outlet passage, and wherein each leading seal is externally subjected to pressurized material source pressure; and
(d) subsequent to step (c), ceasing operation of the dispensing gun, wherein each material inlet passage ceasing being in fluid communication with the at least one outlet passage, and wherein each leading seal ceases being externally subjected to pressurized material source pressure.

17. The method according to claim 16
wherein the gun includes a body,
wherein the body comprises a dispense segment including each material inlet passage and the at least one outlet passage, and
wherein the body comprises a modular valve segment including each dispense pin, each valve arrangement, and each barrier fluid chamber,
wherein in steps (a)-(c) the valve segment is removably connected to the dispense segment,
and further comprising:
(e) replacing the valve segment with another valve segment, wherein the replacing includes:
disconnecting the valve segment from the dispense segment, and
connecting the another valve segment to the dispense segment;
(f) subsequent to step (e), operating the dispensing gun with the another valve segment to dispense materials therefrom.

18. A material dispensing gun for dispensing at least two individual materials as a multi-part combination material comprising:
a body,
wherein the body includes at least two fluid inlets,
wherein the at least two fluid inlets include a first inlet passage and a second inlet passage,
wherein the first inlet passage is adapted to receive therein a first material,
wherein the second inlet passage is adapted to receive therein a second material different from the first material,
wherein the body includes at least two interior passages,
wherein the at least two interior passages include a first interior passage and a second interior passage,
wherein the first interior passage is in fluid connection with the first inlet passage,
wherein the first interior passage is located downstream of the first inlet passage,
wherein the second interior passage is in fluid connection with the second inlet passage,
wherein the second interior passage is located downstream of the second inlet passage,
wherein the body includes at least two chambers,
wherein the at least two chambers include a first chamber and a second chamber,
wherein the first chamber is in fluid connection with the first interior passage,
wherein the first chamber is located downstream of the first interior passage,
wherein the second chamber is in fluid connection with the second interior passage,
wherein the second chamber is located downstream of the second interior passage,
wherein the body includes at least two fluid outlets,
wherein the at least two fluid outlets include a first outlet and a second outlet,
wherein the first outlet is in fluid connection with the first chamber,
wherein the first outlet is located downstream of the first chamber,
wherein the first outlet is configured to enable a first material to be dispensed therethrough,
wherein the second outlet is in fluid connection with the second chamber,
wherein the second outlet is located downstream of the second chamber,
wherein the second outlet is configured to enable a second material to be dispensed therethrough,
wherein the body includes at least two axially movable dispense pins,
wherein the at least two axially movable dispense pins include a first dispense pin and a second dispense pin,
wherein the first dispense pin includes a first end and a second end,
wherein the first end is located between the second end and the first outlet,
wherein the first end comprises a first plunger,
wherein the second dispense pin includes a first end and a second end,
wherein the first end of the second dispense pin is located between the second end of the second dispense pin and the second outlet,
wherein the first end of the second dispense pin comprises a second plunger,
wherein the body includes at least two barrier fluid chambers,
wherein the at least two barrier fluid chambers include a first barrier fluid chamber and a second barrier fluid chamber,
wherein the first barrier fluid chamber is bounded by a first end seal arrangement and a second end seal arrangement,
wherein the first dispense pin extends through the first end seal arrangement and the second end seal arrangement,
wherein the second barrier fluid chamber is bounded by a first end seal arrangement and a second end seal arrangement,
wherein the second dispense pin extends through the first end seal arrangement and the second end seal arrangement of the second barrier fluid chamber,
wherein the body includes at least two valve arrangements,
wherein the at least two valve arrangements include a first valve arrangement and a second valve arrangement,
wherein the first valve arrangement is located between of the first interior passage and the first inlet passage,
wherein the first valve arrangement includes a first seal arrangement and the first plunger,
wherein the first plunger is movable relative to the first seal arrangement between a valve closed position and a valve open position,
wherein the first plunger in the valve closed position engages the first seal arrangement,
wherein the first plunger in the valve closed position prevents flow of a first material from the first inlet passage into the first interior passage,
wherein the first plunger in the valve open position is disengaged from the first seal arrangement,
wherein the first plunger in the valve open position permits flow of a first material from the first inlet passage into the first interior passage,
wherein the second valve arrangement is located between of the second interior passage and the second inlet passage,
wherein the second valve arrangement includes a second seal arrangement and the second plunger,
wherein the second plunger is movable relative to the second seal arrangement between a valve closed position and a valve open position,
wherein the second plunger in the valve closed position engages the second seal arrangement,
wherein the second plunger in the valve closed position prevents flow of a second material from the second inlet passage into the second interior passage,
wherein the second plunger in the valve open position is disengaged from the second seal arrangement,
wherein the second plunger in the valve open position permits flow of a second material from the second inlet passage into the second interior passage,
at least one actuator,
wherein the at least one actuator is in operative connection with the first dispense pin,
wherein the at least one actuator is operative to cause the first plunger to axially move between the valve closed position and the valve open position of the first plunger,
wherein the at least one actuator is in operative connection with the second dispense pin,
wherein the at least one actuator is operative to cause the second plunger to axially move between the valve closed position and the valve open position of the second plunger,
wherein the at least one actuator is operative to cause the first and second valve arrangements to simultaneously be in respective open positions enabling both a first material to flow from the first inlet passage through the first outlet and a second material to flow from the second inlet passage through the second outlet.

19. The apparatus according to claim 18 wherein the body includes a plurality of replaceable modular body segments,
wherein the modular body segments include a dispense segment and a modular valve segment,
wherein the dispense segment includes each fluid inlet, each chamber, and each fluid outlet,
wherein the valve segment includes each dispense pin, each valve arrangement, each interior passage, each barrier fluid chamber, and the at least one actuator,
wherein the valve segment is removably connected to the dispense segment.

20. The apparatus according to claim 18 wherein in the valve open position the first plunger is located in the first interior passage, and wherein in the valve open position the second plunger is located in the second interior passage.
